(19) United States
(12) Patent Application Publication
(10) Pub. No.: US 2025/0226697 A1
(43) Pub. Date: Jul. 10, 2025

(54) WIRELESS POWER RECEIVING DEVICE AND ELECTRONIC DEVICE

(71) Applicant: Murata Manufacturing Co., Ltd., Kyoto-fu (JP)

(72) Inventors: Koyo KAIWA, Nagaokakyo-shi (JP); Tatsuya HOSOTANI, Nagaokakyo-shi (JP)

(73) Assignee: Murata Manufacturing Co., Ltd., Kyoto-fu (JP)

(21) Appl. No.: 19/088,137

(22) Filed: Mar. 24, 2025

Related U.S. Application Data
(63) Continuation of application No. PCT/JP2023/035971, filed on Oct. 2, 2023.

(30) Foreign Application Priority Data
Oct. 26, 2022 (JP) 2022-171768

(51) Int. Cl. H02J 50/12; H02J 7/00; H02J 50/00; H02M 7/00; H02M 7/04; H02M 7/217

(52) U.S. Cl. CPC H02J 50/12; H02J 7/0042; H02J 50/005; H02M 7/003; H02M 7/05; H02M 7/217

(57) ABSTRACT

A wireless power receiving device is a wireless power receiving device that wirelessly receives power from an external power transmitting device and includes a rechargeable battery, a power receiving coil provided to face at least one of an upper surface and a lower surface of the rechargeable battery, a holder structure that has a side plate surrounding a side surface of the rechargeable battery and holds the rechargeable battery, a charging circuit that is provided on or in the side plate of the holder structure and controls charging of the rechargeable battery, and an external output terminal connected to the side plate of the holder structure for establishing an electrical connection to an external mounting board. The external output terminal is provided at a position that does not overlap either the rechargeable battery or the power receiving coil in plan view.

### CROSS-REFERENCE TO RELATED APPLICATIONS

This application claims benefit of priority to International Patent Application No. PCT/JP2023/035971, filed Oct. 2, 2023, and to Japanese Patent Application No. 2022-171768, filed Oct. 26, 2022, the entire contents of each are incorporated herein by reference.

### BACKGROUND

### Technical Field

The present disclosure relates to a wireless power receiving device and an electronic device.

### Background Art

Wireless power receiving devices that are capable of wirelessly receiving power and charging rechargeable batteries have been known. Japanese Unexamined Patent Application Publication No. 2018-186092 describes a battery unit that includes a battery, a board arranged on a side of the battery, a holder holding the battery and the board, and a coil for wireless power transfer. A positive terminal and a negative terminal that are to be electrically connected to an external device are provided on an exposed surface of the board.

Japanese Unexamined Patent Application Publication No. 2019-40860 describes a battery pack that includes a rechargeable battery, a coil member arranged on the upper side of the rechargeable battery, and a circuit board that is arranged on the upper side of the rechargeable battery and is electrically connected to the rechargeable battery and the coil member.

### SUMMARY

In the battery unit of Japanese Unexamined Patent Application Publication No. 2018-186092, terminals for electrical connection with an external device are provided on a side of the battery, and thus, a cable or a connector for connecting the external device and the terminals is required. Because of this, there is a possibility that the connection between the battery unit and the external device becomes cumbersome.

In the battery pack of Japanese Unexamined Patent Application Publication No. 2019-40860, the circuit board is arranged on the upper side of the rechargeable battery. Thus, there is a possibility that size reduction of the battery pack in the height direction of the rechargeable battery becomes difficult.

Accordingly, the present disclosure provides a wireless power receiving device and an electronic device, each of which can reduce the thickness thereof and facilitate easy connection to an external device.

A wireless power receiving device according to one aspect of the present disclosure is a wireless power receiving device that wirelessly receives power from an external power transmitting device and includes a rechargeable battery; a power receiving coil provided to face at least one of an upper surface and a lower surface of the rechargeable battery; a holder structure that has a side plate surrounding a side surface of the rechargeable battery and holds the rechargeable battery; a charging circuit that is provided on or in the side plate of the holder structure and controls charging of the rechargeable battery; and an external output terminal connected to the side plate of the holder structure for establishing an electrical connection to an external mounting board. The external output terminal is provided at a position that does not overlap either the rechargeable battery or the power receiving coil in plan view.

An electronic device according to one aspect of the present disclosure includes: the wireless power receiving device described above; a mounting board that includes a mounting terminal provided on a principal surface thereof and a plurality of wiring lines; and an electronic component provided on or in the mounting board, wherein the external output terminal of the wireless power receiving device is connected to the mounting terminal of the mounting board and is electrically connected to the electronic component using the wiring line, and the plurality of wiring lines of the mounting board is not provided in areas that overlap the rechargeable battery and the power receiving coil in plan view.

According to the wireless power receiving device and the electronic device of the present disclosure, it becomes possible to reduce the thickness thereof and facilitate easy connection to an external device.

### BRIEF DESCRIPTION OF THE DRAWINGS

FIG. 1 is a perspective view schematically illustrating a configuration of a wireless power receiving device according to a first embodiment;

FIG. 2 is a II-II′ sectional view of FIG. 1;

FIG. 3 is a geometric net schematically illustrating a wireless power receiving device according to an embodiment in an unfolded state;

FIG. 4 is a sectional view illustrating a configuration of an electronic device according to a second embodiment;

FIG. 5 is a circuit diagram illustrating a wireless power transfer device according to a third embodiment; and

FIG. 6 is a circuit diagram illustrating a wireless power transfer device according to a modification.

### DETAILED DESCRIPTION

Hereinafter, embodiments of a wireless power receiving device and an electronic device of the present disclosure are described in detail with reference to the drawings. Note that the present disclosure is not limited by these embodiments. Needless to say, each embodiment is for illustrative purposes only, and constituent elements illustrated in different embodiments may be combined or partially exchanged. In the second and subsequent embodiments, descriptions regarding matters common to those in the first embodiment will be omitted, and only points different from those in the first embodiment will be described. Particularly, similar actions and effects produced by similar constituent elements will not be repeated in each embodiment.

### First Embodiment

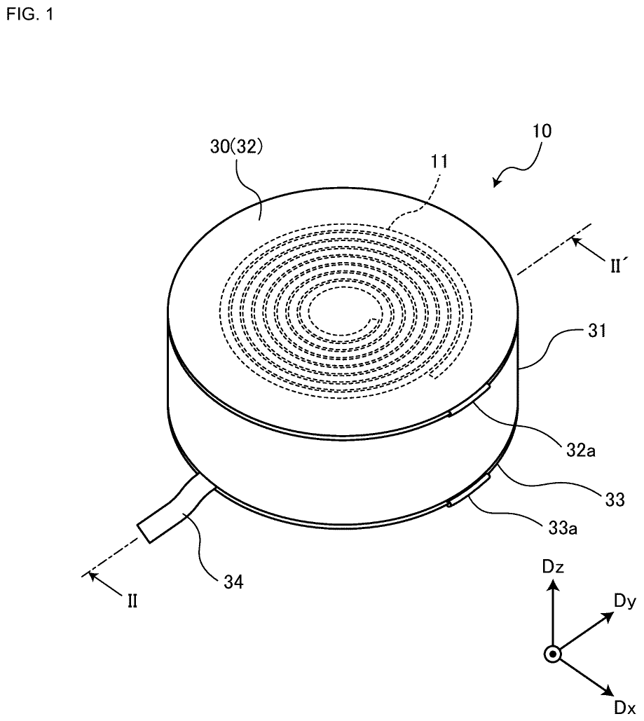

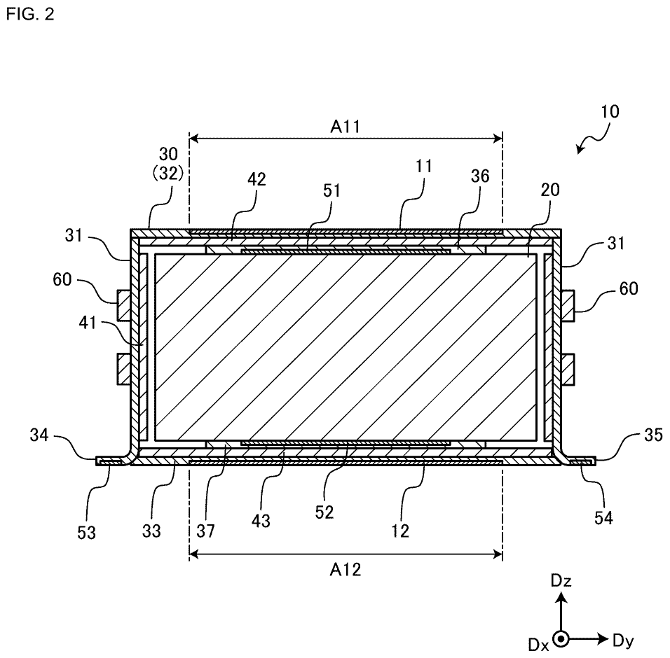

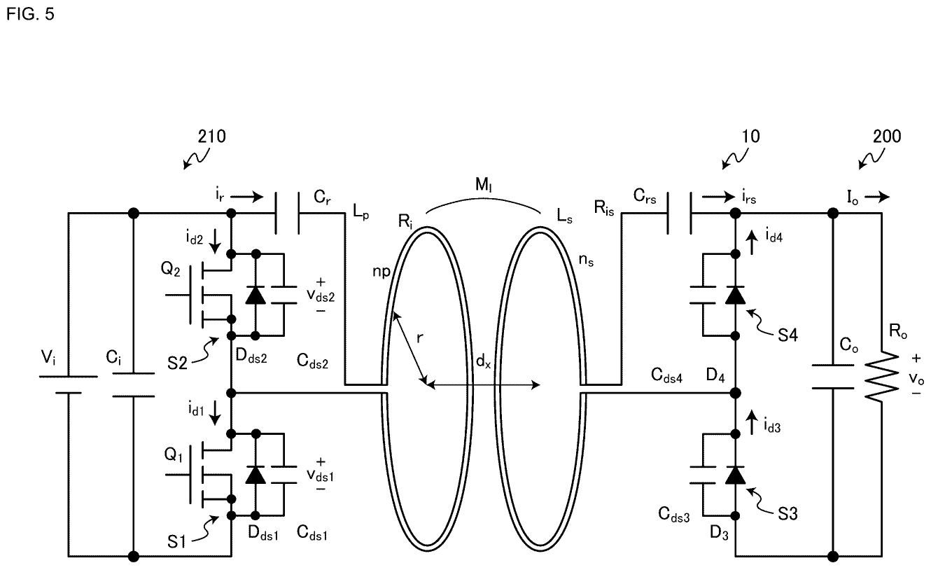

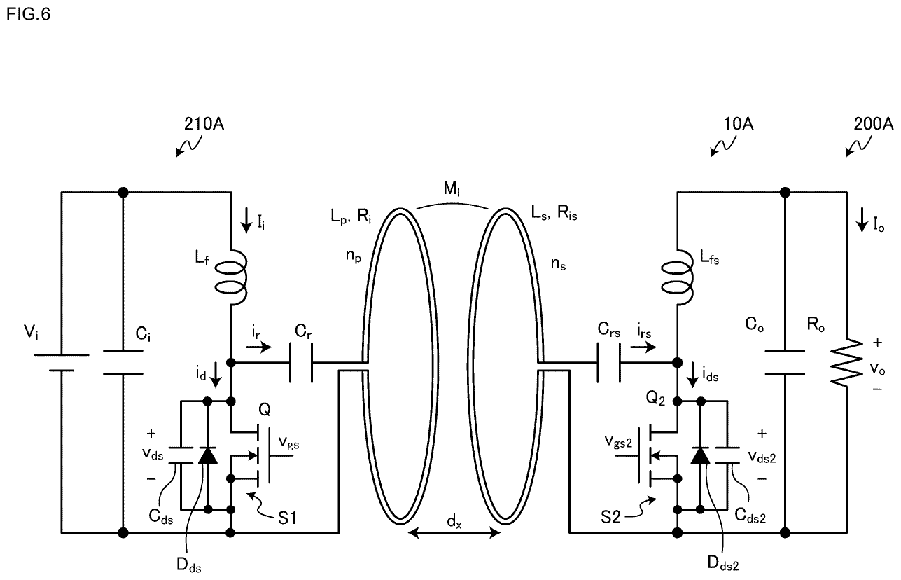

FIG. 1 is a perspective view schematically illustrating a configuration of a wireless power receiving device according to the first embodiment. FIG. 2 is a II-II′ sectional view of FIG. 1. A wireless power receiving device 10 according to the present embodiment is a device that wirelessly receives power from an external wireless power transmitting device 210 or 210A (see FIG. 5 or FIG. 6) and charges a rechargeable battery 20. The wireless power receiving device 10 is installed in a wearable device such as, for example, a hearing aid, a wireless earphone, or the like. The rechargeable battery 20 included in the wireless power receiving device 10 is used as a power supply of the wearable device. Note that the device in which the wireless power receiving device 10 is to be installed is not limited to the above examples.

As illustrated in FIG. 1 and FIG. 2, the wireless power receiving device 10 includes the rechargeable battery 20, power receiving coils 11 and 12, a holder structure 30, a plurality of magnetic bodies 41, 42, and 43, a positive connection terminal 51, a negative connection terminal 52, external output terminals 53 and 54, and electronic components 60.

Note that in the following description, one direction in a plane parallel to a surface of a bottom plate 33 of the holder structure 30 is defined as a first direction Dx. Further, a direction orthogonal to the first direction Dx in the plane parallel to the surface of the bottom plate 33 is defined as a second direction Dy. Further, a direction orthogonal to both the first direction Dx and the second direction Dy is defined as a third direction Dz. The third direction Dz is a direction normal to the bottom plate 33 of the holder structure 30. Further, in the present specification, plan view shows the spatial relationship viewed in the third direction Dz.

The rechargeable battery 20 illustrated in FIG. 2 is a coin type battery or a button type battery. That is to say, the size of the rechargeable battery 20 in the third direction Dz (height direction) is smaller than the diameter of the rechargeable battery 20 in plan view. A positive terminal is formed on one of the upper surface and the lower surface of the rechargeable battery 20, and a negative terminal is formed on the other of the upper surface and the lower surface of the rechargeable battery 20. The rechargeable battery 20 is made up of, for example, a lithium-ion battery. According to this, the wireless power receiving device 10 in which the rechargeable battery 20 is installed can be suitably used for a small electronic device such as a hearing aid, a wireless earphone, or the like.

As illustrated in FIG. 1 and FIG. 2, the holder structure 30 includes a side plate 31, a top plate 32, the bottom plate 33, and a plurality of tab parts 34, 35, 36, and 37. The side plate 31 has a cylindrical shape that surrounds a side surface of the rechargeable battery 20. The top plate 32 is provided so as to cover an opening formed on the upper end side (one of the third direction Dz) of the side plate 31. The top plate 32 is joined to part of the upper end side of the side plate 31 by a hinge part 32a and is provided so as to be able to open and close. The top plate 32 is arranged so as to face the upper surface of the rechargeable battery 20 in the closed state. The bottom plate 33 is provided on the other side of the top plate 32 and is provided so as to cover an opening formed on the lower end side (the other of the third direction Dz) of the side plate 31. The bottom plate 33 is joined to part of a lower end portion of the side plate 31 by a hinge part 33a and is provided so as to be able to open and close. The bottom plate 33 is arranged so as to face the lower surface of the rechargeable battery 20 in the closed state.

As described above, the rechargeable battery 20 is stored in the space surrounded by the side plate 31, the top plate 32, and the bottom plate 33 of the holder structure 30 and is held mechanically. Further, the rechargeable battery 20 is provided such that the rechargeable battery 20 can be removed from the holder structure 30 after opening the top plate 32. In the wireless power receiving device 10, the rechargeable battery 20 can be easily removed and replaced with another rechargeable battery 20 when the performance of the rechargeable battery 20 decreases after repeating charging and discharging of the rechargeable battery 20.

The side plate 31, the top plate 32, the bottom plate 33, and the plurality of tab parts 34, 35, 36, and 37 of the holder structure 30 are formed using a common circuit board. The holder structure 30 is formed using a resin board as a base and is made up of a wiring board including various wiring lines and terminals. The holder structure 30 is made up of a flexible printed circuit (FPC) board composed of a resin material such as, for example, polyimide or a printed circuit board (PCB) composed of glass epoxy resin. The holder structure 30 may be formed by combining a flexible printed circuit board and a printed circuit board if need arises.

The power receiving coils 11 and 12 are provided for receiving power from an electromagnetic field generated by the external wireless power transmitting device 210 or 210A (see FIG. 5 or FIG. 6). The power receiving coil 11 is provided on or in the top plate 32 of the holder structure 30 to face the upper surface of the rechargeable battery 20. The power receiving coil 12 is provided on or in the bottom plate 33 of the holder structure 30 to face the lower surface of the rechargeable battery 20. In the third direction Dz, the rechargeable battery 20 is arranged between the power receiving coil 11 and the power receiving coil 12. As illustrated in FIG. 1, the power receiving coil 11 is formed using a spiral-type plane coil. As is the case with the power receiving coil 11, the power receiving coil 12 is also formed using a spiral-type plane coil. However, the power receiving coils 11 and 12 may have any configuration as long as the power receiving coils 11 and 12 can receive power from an external electromagnetic field.

Note that the power receiving coil 11 or 12 may be provided on at least one of the upper surface and the lower surface of the rechargeable battery 20. That is to say, one of the power receiving coil 11 and the power receiving coil 12 may be omitted. However, the configuration in which the power receiving coil 11 and the power receiving coil 12 are respectively provided on or in the top plate 32 and the bottom plate 33 allows the wireless power receiving device 10 to receive power from both the upper surface side and the lower surface side of the rechargeable battery 20.

The plurality of magnetic bodies 41, 42, and 43 are provided on inner side surfaces of the holder structure 30 and are arranged between the holder structure 30 and the rechargeable battery 20. More specifically, the magnetic body 41 is provided on the inner circumferential surface (surface facing the rechargeable battery 20) of the side plate 31 of the holder structure 30 and is arranged between the side surface of the rechargeable battery 20 and the side plate 31 of the holder structure 30. The magnetic body 42 has a planar shape and is provided on the lower side surface (surface facing the rechargeable battery 20) of the top plate 32 of the holder structure 30. Furthermore, the magnetic body 42 is arranged between the upper surface of the rechargeable battery 20 and the power receiving coil 11. The magnetic body 43 has a planar shape and is provided on the upper side surface (surface facing the rechargeable battery 20) of the bottom plate 33 of the holder structure 30. Furthermore, the magnetic body 43 is arranged between the lower surface of the rechargeable battery 20 and the power receiving coil 12.

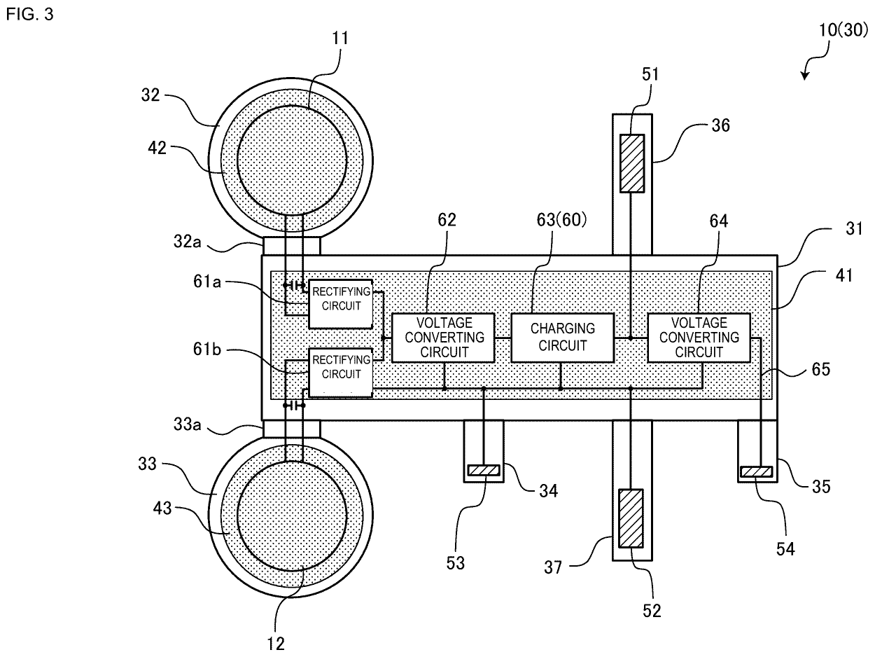

FIG. 3 is a geometric net schematically illustrating a wireless power receiving device according to an embodiment in an unfolded state. In FIG. 3, the areas in which the plurality of magnetic bodies 41, 42, and 43 are provided are shaded by hatching. Further, FIG. 3 schematically illustrates an example of configuration of a circuit formed at the side plate 31 in the form of block diagram.

As illustrated in FIG. 3, the magnetic body 41 is provided so as to overlap almost the entire area of the side plate 31 of the holder structure 30. Further, the magnetic body 42 is provided so as to overlap almost the entire area of the top plate 32 and is provided so as to cover the entire surface of the power receiving coil 11. The magnetic body 43 is provided so as to overlap almost the entire area of the bottom plate 33 and is provided so as to cover the entire surface of the power receiving coil 12.

Each of the plurality of magnetic bodies 41, 42, and 43 is a composite material of, for example, magnetic ferrite powder and a resin material, which is shaped in a sheet-like form, or a sintered magnetic ferrite thin plate. The magnetic bodies 41, 42, and 43 constitute part of a magnetic path of a magnetic flux that interlinks with the power receiving coils 11 and 12. According to this, the magnetic path is formed such that power can be received efficiently from an external electromagnetic field.

As illustrated in FIG. 2, the positive connection terminal 51 is provided on or in the tab part 36 of the holder structure 30 and is connected to the positive terminal of the rechargeable battery 20. The tab part 36 and the positive connection terminal 51 are arranged between the magnetic body 42 and the rechargeable battery 20 in the third direction Dz. In other words, the magnetic body 42 is arranged between the tab part 36 and the top plate 32 in the third direction Dz.

The negative connection terminal 52 is provided on or in the tab part 37 of the holder structure 30 and is connected to the negative terminal of the rechargeable battery 20. The tab part 37 and the negative connection terminal 52 are arranged between the magnetic body 43 and the rechargeable battery 20 in the third direction Dz. In other words, the magnetic body 43 is arranged between the tab part 37 and the bottom plate 33 in the third direction Dz.

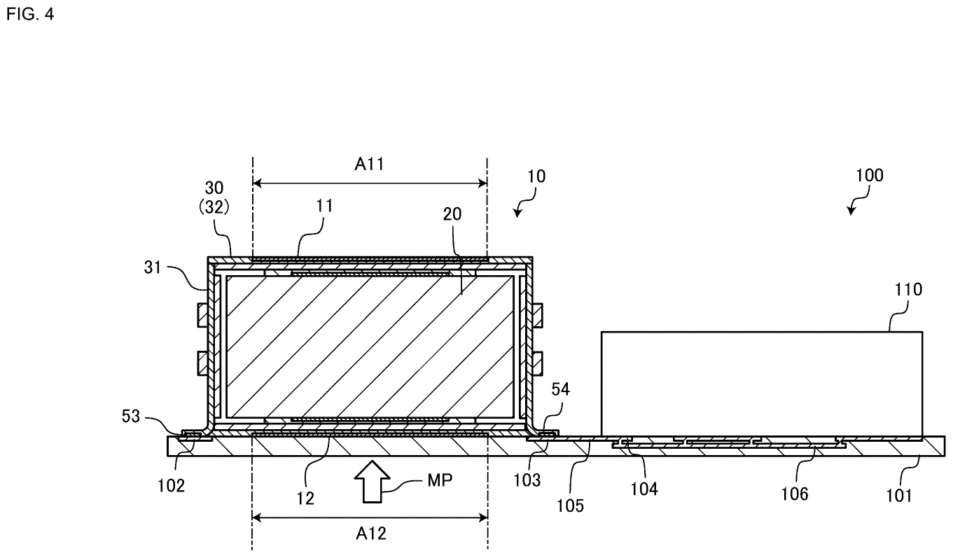

The external output terminals 53 and 54 are provided on or in the tab parts 34 and 35 of the holder structure 30, respectively. The tab parts 34 and 35 are connected to the lower end of the side plate 31 of the holder structure 30 and are extended outside the side plate 31 (direction away from the rechargeable battery 20). The external output terminals 53 and 54 are terminals for establishing the electrical connection to an external mounting board 101 (see FIG. 4) and are provided on the lower surfaces of the tab parts 34 and 35, respectively. The lower surfaces of the tab parts 34 and 35 (lower surfaces of the external output terminals 53 and 54) are provided in the same plane as the lower surface of the bottom plate 33 of the holder structure 30.

As illustrated in FIG. 3, in the state where the holder structure 30 is unfolded in one plane, the tab part 36 is connected to a side on the upper end side of the side plate 31 and extends in a direction orthogonal to the side on the upper end side of the side plate 31. Each of the tab parts 34, 35, and 37 is connected to a side on the lower end side of the side plate 31 and extends in a direction orthogonal to the side on the lower end side of the side plate 31. Further, the top plate 32 is connected to the side on the upper end side of the side plate 31 via the hinge part 32a. The bottom plate 33 is connected to the side on the lower end side of the side plate 31 via the hinge part 33a. As described above, the side plate 31, the top plate 32, the bottom plate 33, and the plurality of tab parts 34, 35, 36, and 37 of the holder structure 30 are all formed as continuous parts using a common circuit board.

When the holder structure 30 is assembled, the top plate 32 and the tab part 36 are bent toward the inner circumferential surface side of the side plate 31. Further, the bottom plate 33 and the tab part 37 are bent toward the inner circumferential surface side of the side plate 31. The tab parts 34 and 35 are bent toward the outer circumferential surface side of the side plate 31, which is the opposite side to the bottom plate 33 and the tab part 37.

According to the configuration described above, as illustrated in FIG. 2, the positive connection terminal 51 and the negative connection terminal 52 are provided at positions that overlap the rechargeable battery 20 in plan view. Further, in plan view, the external output terminals 53 and 54 are provided at positions that do not overlap either the rechargeable battery 20, the power receiving coil 11, or the power receiving coil 12. In other words, in wireless power transfer using the external wireless power transmitting device 210 or 210A (see FIG. 5 or FIG. 6), the magnetic path of a major magnetic flux interlinking with the power receiving coils 11 and 12 does not cross the external output terminals 53 and 54. Here, ideally, the magnetic path of the major magnetic flux interlinking with the power receiving coils 11 and 12 is formed so as to pass through the area surrounded by the power receiving coils 11 and 12 in the direction (third direction Dz) orthogonal to the planes including the respective power receiving coils 11 and 12.

According to this, the wireless power receiving device 10 of the present embodiment can suppress blocking, caused by the external output terminals 53 and 54, wiring lines 65, and the like provided on or in the holder structure 30, of the magnetic path of the major magnetic flux interlinking with the power receiving coils 11 and 12. Accordingly, the power receiving coils 11 and 12 can efficiently receive power from an external electromagnetic field.

As illustrated in FIG. 2, the electronic components 60 are provided on or in the side plate 31 of the holder structure 30. More specifically, the electronic components 60 are provided on the outer circumferential surface (opposite side of the surface facing the rechargeable battery 20) of the side plate 31. The electronic component 60 is made up of, for example, an IC (Integrated Circuit) chip. Alternatively, the electronic component 60 may be configured to include a surface mount device such as a capacitor, an inductor, or the like.

The electronic components 60 include various circuits that control the charging of the rechargeable battery 20. More specifically, as illustrated in FIG. 3, the electronic components 60 include rectifying circuits 61a and 61b, voltage converting circuits 62 and 64, and a charging circuit 63. Each of the rectifying circuits 61a and 61b, the voltage converting circuits 62 and 64, and the charging circuit 63 may be configured as a separate electronic component 60 (IC chip). Of the rectifying circuits 61a and 61b, the voltage converting circuits 62 and 64, and the charging circuit 63, a plurality of circuits may be formed together as a single electronic component 60 (IC chip).

Each of the rectifying circuits 61a and 61b, the voltage converting circuits 62 and 64, and the charging circuit 63 is provided on or in the side plate 31 of the holder structure 30. The rectifying circuits 61a and 61b, the voltage converting circuits 62 and 64, and the charging circuit 63 are electrically connected to each other via the wiring lines 65 formed on or in the side plate 31.

The rectifying circuits (power receiving rectifying circuits) 61a and 61b are circuits that are provided on or in the side plate 31 of the holder structure 30, convert power received by the power receiving coils 11 and 12 into DC voltages, and supply the DC voltages to the voltage converting circuit 62. Input sides of the rectifying circuits 61a and 61b are electrically connected to the power receiving coils 11 and 12, respectively. Output sides of the rectifying circuits 61a and 61b are each electrically connected to the voltage converting circuit 62. Further, power receiving resonant capacitors are included. The power receiving resonant capacitors are provided on or in the side plate 31 of the holder structure 30 and constitute power receiving resonant circuits with the power receiving coils 11 and 12.

The voltage converting circuit 62 is a circuit that converts the DC voltages supplied from the rectifying circuits 61a and 61b into a predetermined voltage value suitable for charging the rechargeable battery 20 and outputs the converted DC voltage to the charging circuit 63.

The charging circuit 63 is a circuit that controls charging of the rechargeable battery 20. The input side of the charging circuit 63 is connected to the voltage converting circuit 62. The output side of the charging circuit 63 is electrically connected to the positive terminal of the rechargeable battery 20 via the positive connection terminal 51 and is also electrically connected to the negative terminal of the rechargeable battery 20 via the negative connection terminal 52.

The voltage converting circuit 64 is a circuit that converts a DC voltage supplied from the rechargeable battery 20 into a voltage value suitable for an electronic component 110 included in an external electronic device 100 (see FIG. 4). The input side of the voltage converting circuit 64 is electrically connected to the rechargeable battery 20. The output side of the voltage converting circuit 64 is electrically connected to the external electronic device 100 via the external output terminals 53 and 54.

One of the external output terminals 53 and 54 is connected to a reference potential (for example, GND). In the example illustrated in FIG. 3, the external output terminal 53 is connected to the reference potential to provide the reference potential to each of the rectifying circuits 61a and 61b, the voltage converting circuits 62 and 64, and the charging circuit 63.

Note that the circuit configuration provided on or in the side plate 31 of the holder structure 30 is a mere example and can be changed as needed. For example, the voltage converting circuit 64 to be connected to the external output terminals 53 and 54 may be omitted. In this case, a circuit that corresponds to the voltage converting circuit 64 may be provided on or in the mounting board 101 or the electronic component 110 of the external electronic device 100 (see FIG. 4).

According to the configuration described above, in the wireless power receiving device 10 of the present embodiment, the electronic components 60 including the charging circuit 63 and the like are provided on or in the side plate 31 of the holder structure 30. Further, the electronic components 60 are not provided on either the upper surface side or the lower surface side of the rechargeable battery 20. According to this, the wireless power receiving device 10 can reduce the thickness of the whole configuration including the electronic components 60. Further, the side plate 31, the top plate 32, the bottom plate 33, and the plurality of tab parts 34, 35, 36, and 37 of the holder structure 30 are all formed as continuous parts using a common circuit board, and the holder structure 30 formed using the circuit board and the rechargeable battery 20 are formed as a single unit. Thus, the conservation of space can be achieved.

Further, the external output terminals 53 and 54 are provided at the positions that do not overlap either the rechargeable battery 20, the power receiving coil 11, or the power receiving coil 12 in plan view. According to this, the external output terminals 53 and 54 are configured so as not to cross the magnetic path of the major magnetic flux during the wireless power transfer. Further, the electronic components 60 including the charging circuit 63 and the like are provided on or in the side plate 31 of the holder structure 30. Various circuits such as the electronic components 60 and the like and the wiring lines 65 formed on or in the side plate 31 are also arranged so as not to cross the magnetic path of the major magnetic flux during the wireless power transfer. Accordingly, the power receiving coils 11 and 12 can efficiently receive power from an external electromagnetic field.

Further, the external output terminals 53 and 54 are provided on or in the tab parts 34 and 35 of the holder structure 30 and are formed as mounting terminals for establishing the electrical connection to the external mounting board 101 (see FIG. 4). Furthermore, the positive connection terminal 51 and the negative connection terminal 52 are provided on or in the tab parts 36 and 37 of the holder structure 30 and are formed as connection terminals to the rechargeable battery 20. According to this, no other component such as a cable, a connector, or the like is needed for electrically connecting the rechargeable battery 20 to the external electronic device 100. This can facilitate easy connection to an external device.

Further, in the wireless power transfer using the external wireless power transmitting device 210 or 210A (see FIG. 5 or FIG. 6), the frequency of the magnetic field interlinking with the power receiving coils 11 and 12 is 6.78 MHz or 13.56 MHz. Because of this, the wireless power receiving device 10 can suppress electromagnetic interference.

### Second Embodiment

FIG. 4 is a sectional view illustrating a configuration of an electronic device according to the second embodiment. In the second embodiment, the electronic device 100 in which the wireless power receiving device 10 according to the first embodiment described above is mounted on the mounting board 101 is described.

The electronic device 100 of the present embodiment is a wearable device such as, for example, a hearing aid, a wireless earphone, or the like. However, the electronic device 100 is not limited thereto and may be a mobile information terminal, a wristwatch type terminal, an eyeglasses type terminal, or the like. Further, the electronic device 100 may be any type of electronic device such as an electrical power tool, an electric vehicle, or the like.

The electronic device 100 includes the wireless power receiving device 10, the mounting board 101, and the electronic component 110. The wireless power receiving device 10 and the electronic component 110 are mounted on a principal surface of the mounting board 101. The rechargeable battery 20 installed in the wireless power receiving device 10 is used as a power supply of the electronic device 100.

The electronic component 110 is made up of an IC chip and includes a functional circuit of the electronic device 100. FIG. 4 illustrates only one electronic component to facilitate understanding of the explanation. However, the electronic device 100 may include a plurality of electronic components 110. Further, the electronic component 110 is not limited to the IC chip and may include a surface mount device such as a capacitor, an inductor, or the like.

The mounting board 101 is formed using a resin board, a ceramic board, or the like and includes mounting terminals 102 and 103, an electronic component mounting terminal 104, a connection wiring line 105, and a plurality of wiring lines 106. The mounting terminals 102 and 103 and the electronic component mounting terminal 104 are provided on the principal surface of the mounting board 101. The wireless power receiving device 10 is connected to the mounting terminals 102 and 103 of the mounting board 101. More specifically, the external output terminals 53 and 54 of the wireless power receiving device 10 are electrically connected to the mounting terminals 102 and 103 using an electrically conductive material such as solder or the like. Because the wireless power receiving device 10 has the external output terminals 53 and 54, the wireless power receiving device 10 can be mounted on the mounting board 101 by using reflow, for example. Further, the electronic component 110 is connected to the electronic component mounting terminal 104 of the mounting board 101.

The connection wiring line 105 and the plurality of wiring lines 106 are provided on the principal surface and an inner layer of the mounting board 101. The connection wiring line 105 and the plurality of wiring lines 106 are composed of an electrically conductive material such as, for example, silver (Ag), copper (Cu), or the like, and are provided for establishing the electrical connections between the components of the electronic device 100. Of the plurality of wiring lines 106 provided on or in the mounting board 101, the connection wiring line 105 is a wiring line that electrically connects the wireless power receiving device 10 and the electronic component 110 and constitutes a closed circuit between the wireless power receiving device 10 and the electronic component 110. In other words, the wireless power receiving device 10 is electrically connected to the electronic component 110 via the connection wiring line 105.

In the electronic device 100 of the present embodiment, the connection wiring line 105 and the plurality of wiring lines 106 of the mounting board 101 are not provided in an area A11 or A12. The areas A11 and A12 overlap the rechargeable battery 20 and the power receiving coils 11 and 12 in plan view. That is to say, the mounting terminals 102 and 103 of the mounting board 101 are provided at the positions that do not overlap either the rechargeable battery 20, the power receiving coil 11, or the power receiving coil 12 in plan view. Further, as described above, the external output terminals 53 and 54 of the wireless power receiving device 10 are provided at the positions that do not overlap either the rechargeable battery 20, the power receiving coil 11, or the power receiving coil 12 in plan view.

According to the configuration described above, in the wireless power transfer using the external wireless power transmitting device 210 or 210A (see FIG. 5 or FIG. 6), the magnetic path of the major magnetic flux interlinking with the power receiving coils 11 and 12 does not cross either the connection wiring line 105 or the plurality of wiring lines 106 of the mounting board 101. Further, in the wireless power transfer using the external wireless power transmitting device 210 or 210A (see FIG. 5 or FIG. 6), the magnetic path of the major magnetic flux interlinking with the power receiving coils 11 and 12 does not cross a circuit that serves as a shortest current path that is configured to include the external output terminals 53 and 54 and part of a circuit included in the external mounting board 101 that is electrically connected using the external output terminals 53 and 54.

According to this, the electronic device 100 of the present embodiment can suppress blocking, caused by the connection wiring line 105, the plurality of wiring lines 106, and the like of the mounting board 101, of the magnetic path of the major magnetic flux interlinking with the power receiving coils 11 and 12. Accordingly, in the wireless power receiving device 10 installed in the electronic device 100, the power receiving coils 11 and 12 can efficiently receive power from an external electromagnetic field.

Further, the present embodiment enables visual observation of parts connecting the external output terminals 53 and 54 of the wireless power receiving device 10 and the mounting terminals 102 and 103 of the mounting board 101, and thus, poor mounting or the like can be easily examined.

### Third Embodiment

FIG. 5 is a circuit diagram illustrating a wireless power transfer device according to the third embodiment. In the third embodiment, a wireless power transfer device 200 that includes the wireless power receiving device 10 according to the first embodiment and a wireless power transmitting device 210 is described.

The wireless power transfer device 200 according to the third embodiment is a device that supplies power through space by intermittently providing DC power to a power transmitting resonant mechanism using a switching circuit and causing the power transmitting resonant mechanism and a power receiving resonant mechanism to interact with each other.

As illustrated in FIG. 5, the wireless power transfer device 200 includes an input power supply Vi in an input part of the wireless power transmitting device 210 and is a system that transfers stable DC energy to a load Ro (for example, the electronic component 110 of FIG. 4) of the wireless power receiving device 10.

The wireless power transmitting device 210 includes a power transmitting side resonant mechanism including a power transmitting coil np, a resonant capacitor Cr, and switching circuits S1 and S2.

The switching circuit S1 is made up of a parallel-connected circuit consisting of a switching element Q1, a diode Dds1, and a capacitor Cds1. Similarly, the switching circuit S2 is made up of a parallel-connected circuit consisting of a switching element Q2, a diode Dds2, and a capacitor Cds2. Hereinafter, the diodes Dds1 and Dds2 are antiparallel diodes (parasitic diodes) of the switching elements Q1 and Q2, respectively. The capacitors Cds1 and Cds2 are parasitic capacitors of the switching elements Q1 and Q2, respectively.

A switching control circuit (not illustrated) intermittently applies a DC voltage to the power transmitting side resonant mechanism to generate a resonant current in the power transmitting side resonant mechanism by alternately turning the switching circuits S1 and S2 on and off at a predetermined switching frequency. The switching control circuit (not illustrated) carries out, for example, a switching operation at 6.78 MHz or 13.56 MHz, which is an international ISM (industrial, scientific and medical) band.

In this example, the wireless power transmitting device 210 is configured to form a half bridge circuit including the two switching circuits S1 and S2.

The wireless power receiving device 10 includes a capacitor Co and a power receiving side resonant mechanism including a power receiving coil ns, a resonant capacitor Crs, and rectifying circuits S3 and S4.

The rectifying circuit S3 is made up of a parallel-connected circuit consisting of a diode D3 and a capacitor Cds3. The rectifying circuit S4 is made up of a parallel-connected circuit consisting of a diode D4 and a capacitor Cds4.

According to the configuration described above, a resonant current flowing in the power receiving side resonant mechanism is rectified by the rectifying circuit S3 or S4 depending on change in the flowing direction of the current, and as a result, a rectified current is supplied to a load.

The power receiving coil ns illustrated in FIG. 5 is configured to include at least one of the power receiving coils 11 and 12 described above using FIG. 1 and FIG. 2. The power transmitting coil np and the power receiving coil ns have a mutual inductance and a leakage inductance. Further, an equivalent mutual capacitance is formed between the power transmitting coil np and the power receiving coil ns.

The power transmitting coil np and the power receiving coil ns constitute an electromagnetic resonance circuit by having a mixture of inductive coupling through the mutual inductance and capacitive coupling through the mutual capacitance. Because of this electromagnetic resonance phenomenon, the wireless power transfer from the wireless power transmitting device 210 to the wireless power receiving device 10 is achieved.

### Modification

FIG. 6 is a circuit diagram illustrating a wireless power transfer device according to a modification. As illustrated in FIG. 6, in a wireless power transfer device 200A according to the modification, a power transmitting side resonant mechanism of the wireless power transmitting device 210A includes a power transmitting coil np, a resonant capacitor Cr, a switching circuit S1, and an inductor Lf. A power receiving side resonant mechanism of a wireless power receiving device 10A includes a power receiving coil ns, a resonant capacitor Crs, a switching circuit S2, and an inductor Lfs.

Because of the working of the switching control circuit (not illustrated), the wireless power receiving device 10A can perform rectification in synchronization with the wireless power transmitting device 210A. Alternatively, the wireless power receiving device 10A may perform rectification without synchronizing with the wireless power transmitting device 210A.

The wireless power transfer device 200A according to the modification is configured so as to have symmetry between the wireless power transmitting device 210A and the wireless power receiving device 10A. Thus, power transmission and power reception can be switched.

Note that the wireless power transfer devices 200 and 200A illustrated in FIG. 5 and FIG. 6 are mere examples, and another configuration may be used. For example, the rectifying circuits S3 and S4 of the wireless power receiving device 10 illustrated in FIG. 5 may include switching elements, as is the case with the switching circuits S1 and S2. Further, for the wireless power transfer devices 200 and 200A, wireless power transfer circuits disclosed in Publications of Japanese Patent No. 5494828, Japanese Patent No. 5321758, and Japanese Patent No. 5817835 can be employed.

As described above, according to the wireless power receiving devices 10 and 10A and the electronic device 100 of the present embodiment, the major magnetic flux interlinking with the power receiving coil does not cross the circuit that serves as the shortest current path configured to include the external output terminals and a circuit included in the external mounting board. Thus, it becomes possible to increase the efficiency of power reception, and also a malfunction of an electric circuit caused by electromagnetic noise is prevented from occurring. Furthermore, it becomes possible to reduce the thickness and facilitate easy connection to an external device, and at the same time, it becomes possible to increase the efficiency of the wireless power transfer system.

Note that the embodiments described above are provided to facilitate understanding of the present disclosure and are not to be construed as limiting the present disclosure. The present disclosure can be modified or improved without departing from its spirit, and the present disclosure also includes equivalents thereof.

Note that the present disclosure can also have the following configurations.

(1) A wireless power receiving device that wirelessly receives power from an external power transmitting device. The wireless power receiving device comprising a rechargeable battery; a power receiving coil provided to face at least one of an upper surface and a lower surface of the rechargeable battery; a holder structure that has a side plate surrounding a side surface of the rechargeable battery and holds the rechargeable battery; a charging circuit that is provided on or in the side plate of the holder structure and controls charging of the rechargeable battery; and an external output terminal connected to the side plate of the holder structure for establishing an electrical connection to an external mounting board. The external output terminal is provided at a position that does not overlap either the rechargeable battery or the power receiving coil in plan view.

(2) The wireless power receiving device according to (1), wherein in wireless power transfer using the external power transmitting device, a magnetic path of a major magnetic flux interlinking with the power receiving coil does not cross the external output terminal.

(3) The wireless power receiving device according to (1) or (2), wherein in wireless power transfer using the external power transmitting device, a magnetic path of a major magnetic flux interlinking with the power receiving coil does not cross a circuit that serves as a shortest current path, the shortest current path being configured to include the external output terminal and part of a circuit included in the external mounting board that is electrically connected using the external output terminal.

(4) The wireless power receiving device according to any one of (1) to (3), wherein the holder structure has a top plate that faces the upper surface of the rechargeable battery and a bottom plate that faces the lower surface of the rechargeable battery, and the power receiving coil is provided on or in each of the top plate and the bottom plate.

(5) The wireless power receiving device according to any one of (1) to (4), further comprising a power receiving resonant capacitor that is provided on or in the side plate of the holder structure and constitutes a power receiving resonant circuit with the power receiving coil.

(6) The wireless power receiving device according to any one of (1) to (5), further comprising a power receiving rectifying circuit that is provided on or in the side plate of the holder structure, converts power received by the power receiving coil into a DC voltage, and supplies the DC voltage to the charging circuit.

(7) The wireless power receiving device according to any one of (1) to (6), further comprising a planar magnetic body provided between the rechargeable battery and the power receiving coil.

(8) The wireless power receiving device according to any one of (1) to (7), wherein in wireless power transfer using the external power transmitting device, a frequency of a magnetic field interlinking with the power receiving coil is 6.78 MHz or 13.56 MHz.

(9) The wireless power receiving device according to any one of (1) to (8), wherein the rechargeable battery is a coin type battery or a button type battery.

(10) An electronic device comprising the wireless power receiving device according to any one of (1) to (9); a mounting board that includes a mounting terminal provided on a principal surface thereof and a plurality of wiring lines; and an electronic component provided on or in the mounting board. The external output terminal of the wireless power receiving device is connected to the mounting terminal of the mounting board and is electrically connected to the electronic component using the wiring line, and the plurality of wiring lines of the mounting board is not provided in areas that overlap the rechargeable battery and the power receiving coil in plan view.

What is claimed is:

1. A wireless power receiving device that wirelessly receives power from an external power transmitting device, the wireless power receiving device comprising:
a rechargeable battery;
a power receiving coil facing at least one of an upper surface and a lower surface of the rechargeable battery;
a holder structure that has a side plate surrounding a side surface of the rechargeable battery and holds the rechargeable battery;
a charging circuit that is on or in the side plate of the holder structure and controls charging of the rechargeable battery; and
an external output terminal connected to the side plate of the holder structure and configured to establish an electrical connection to an external mounting board, wherein
the external output terminal is at a position that does not overlap either the rechargeable battery or the power receiving coil in plan view.

2. The wireless power receiving device according to claim 1, wherein
in wireless power transfer using the external power transmitting device, a magnetic path of a major magnetic flux interlinking with the power receiving coil does not cross the external output terminal.

3. The wireless power receiving device according to claim 1, wherein
in wireless power transfer using the external power transmitting device, a magnetic path of a major magnetic flux interlinking with the power receiving coil does not cross a circuit that serves as a shortest current path, the shortest current path being configured to include the external output terminal and part of a circuit included in the external mounting board that is electrically connected using the external output terminal.

4. The wireless power receiving device according to claim 1, wherein
the holder structure has a top plate that faces the upper surface of the rechargeable battery and a bottom plate that faces the lower surface of the rechargeable battery, and
the power receiving coil is on or in each of the top plate and the bottom plate.

5. The wireless power receiving device according to claim 1, further comprising:
a power receiving resonant capacitor that is on or in the side plate of the holder structure and configures a power receiving resonant circuit with the power receiving coil.

6. The wireless power receiving device according to claim 1, further comprising:
a power receiving rectifying circuit that is on or in the side plate of the holder structure, and is configured to convert power received by the power receiving coil into a DC voltage and supply the DC voltage to the charging circuit.

7. The wireless power receiving device according to claim 1, further comprising:
a planar magnetic body between the rechargeable battery and the power receiving coil.

8. The wireless power receiving device according to claim 1, wherein
in wireless power transfer using the external power transmitting device, a frequency of a magnetic field interlinking with the power receiving coil is 6.78 MHz or 13.56 MHz.

9. The wireless power receiving device according to claim 1, wherein
the rechargeable battery is a coin type battery or a button type battery.

10. An electronic device comprising:
the wireless power receiving device according to claim 1;
a mounting board that includes a mounting terminal on a principal surface thereof and a plurality of wiring lines; and
an electronic component on or in the mounting board, wherein
the external output terminal of the wireless power receiving device is connected to the mounting terminal of the mounting board and is electrically connected to the electronic component using at least one of the wiring lines, and
the plurality of wiring lines of the mounting board is not provided in areas that overlap the rechargeable battery and the power receiving coil in plan view.

11. The wireless power receiving device according to claim 2, wherein
in wireless power transfer using the external power transmitting device, a magnetic path of a major magnetic flux interlinking with the power receiving coil does not cross a circuit that serves as a shortest current path, the shortest current path being configured to include the external output terminal and part of a circuit included in the external mounting board that is electrically connected using the external output terminal.

12. The wireless power receiving device according to claim 2, wherein
the holder structure has a top plate that faces the upper surface of the rechargeable battery and a bottom plate that faces the lower surface of the rechargeable battery, and
the power receiving coil is on or in each of the top plate and the bottom plate.

13. The wireless power receiving device according to claim 3, wherein
the holder structure has a top plate that faces the upper surface of the rechargeable battery and a bottom plate that faces the lower surface of the rechargeable battery, and
the power receiving coil is on or in each of the top plate and the bottom plate.

14. The wireless power receiving device according to claim 2, further comprising:
a power receiving resonant capacitor that is on or in the side plate of the holder structure and configures a power receiving resonant circuit with the power receiving coil.

15. The wireless power receiving device according to claim 3, further comprising:
a power receiving resonant capacitor that is on or in the side plate of the holder structure and configures a power receiving resonant circuit with the power receiving coil.

16. The wireless power receiving device according to claim 2, further comprising:
a power receiving rectifying circuit that is on or in the side plate of the holder structure, and is configured to convert power received by the power receiving coil into a DC voltage and supply the DC voltage to the charging circuit.

17. The wireless power receiving device according to claim 2, further comprising:
a planar magnetic body between the rechargeable battery and the power receiving coil.

18. The wireless power receiving device according to claim 2, wherein
in wireless power transfer using the external power transmitting device, a frequency of a magnetic field interlinking with the power receiving coil is 6.78 MHz or 13.56 MHz.

19. The wireless power receiving device according to claim 2, wherein
the rechargeable battery is a coin type battery or a button type battery.

20. An electronic device comprising:
the wireless power receiving device according to claim 1;
a mounting board that includes a mounting terminal on a principal surface thereof and a plurality of wiring lines; and
an electronic component on or in the mounting board, wherein
the external output terminal of the wireless power receiving device is connected to the mounting terminal of the mounting board and is electrically connected to the electronic component using at least one of the wiring lines, and
the plurality of wiring lines of the mounting board is not provided in areas that overlap the rechargeable battery and the power receiving coil in plan view.
